(19) United States
(12) Patent Application Publication
(10) Pub. No.: US 2025/0122837 A1
(43) Pub. Date: Apr. 17, 2025

(54) Closed-Loop Thermal Management System

(71) Applicant: General Electric Company, Schenectady, NY (US)

(72) Inventors: Gregory Welch DAINES, Cohoes, NY (US); Brian Magann RUSH, Niskayuna, NY (US); Rinaldo Luigi MIORINI, Niskayuna, NY (US)

(21) Appl. No.: 18/487,413

(22) Filed: Oct. 16, 2023

(51) Int. Cl. F02C 7/14; B64D 13/06

(52) U.S. Cl. CPC F02C 7/12

(57) ABSTRACT

A closed-loop thermal management system includes a thermal transport bus configured to circulate a thermal working fluid therethrough, a thermal transport bus including a plurality of fluid conduits configured to circulate a thermal working fluid therethrough; an accumulator including a shell defining a multiphase fluid volume therein configured to contain a multiphase fluid. The shell defines an opening. The accumulator is fluidly coupled to the thermal transport bus in a closed-loop fluid circuit. A temperature regulator is configured to control a temperature of the multiphase fluid inside the multiphase fluid volume.

### FEDERALLY SPONSORED RESEARCH

This invention was made with government support under contract number W911W620C0080 awarded by the Department of Defense. The U.S. government may have certain rights in the invention.

### FIELD

The present disclosure generally relates to closed-loop thermal management systems, and more particularly, to systems that regulate pressure of a thermal working fluid in a closed-loop thermal management system.

### BACKGROUND

Thermal management systems may be utilized in a wide range of applications such as aircraft, electric cars, electrical generators, electrical motors, internal combustion engines, microprocessors, power electronics, etc. In operation it may be necessary to cool these various accessory systems via a thermal management system. Thermal management systems generally include a thermal transport bus or fluid circuit that facilitates the flow of a thermal working fluid through the system at a desired or required average pressure. The thermal working fluid interacts with various heat sources and heat sinks to add or remove heat from various operational components or systems. A changing heat load or ambient environment may adversely affect the average pressure of the thermal working fluid flowing through the thermal transport bus of the thermal management system.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is perspective view of an exemplary aircraft in accordance with an exemplary embodiment of the present disclosure.

FIG. 2 is a schematic cross-sectional view of a ducted turbofan gas turbine engine in accordance with an exemplary embodiment of the present disclosure.

FIG. 3 is a schematic view of a closed-loop thermal management system in accordance with an exemplary embodiment of the present disclosure.

FIG. 4 is a schematic view of the closed-loop thermal management system as shown in FIG. 3, in accordance with an exemplary embodiment of the present disclosure.

FIG. 5 is a schematic view of the closed-loop thermal management system as shown in FIG. 3, according to an exemplary embodiment of the present disclosure.

FIG. 6 is a schematic view of an exemplary accumulator and an exemplary temperature regulator according to an embodiment of the present disclosure.

FIG. 7 is a schematic view of an exemplary accumulator and an exemplary temperature regulator according to an embodiment of the present disclosure.

FIG. 8 is a schematic view of an exemplary accumulator and an exemplary temperature regulator according to an embodiment of the present disclosure.

FIG. 9 is a schematic view of an exemplary accumulator and an exemplary temperature regulator according to an embodiment of the present disclosure.

FIG. 10 is a schematic view of an exemplary accumulator and an exemplary temperature regulator according to an embodiment of the present disclosure.

FIG. 11 is a schematic view of a closed-loop thermal management system in accordance with an exemplary embodiment of the present disclosure.

FIG. 12 is a schematic view of a closed-loop thermal management system in accordance with an exemplary embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations.

Additionally, unless specifically identified otherwise, all embodiments described herein should be considered exemplary.

The singular forms “a”, “an”, and “the” include plural references unless the context clearly dictates otherwise. The term “at least one of” in the context of, e.g., “at least one of A, B, and C” refers to only A, only B, only C, or any combination of A, B, and C.

As used herein, the terms “first”, “second”, and “third” may be used interchangeably to distinguish one component from another and are not intended to signify location or importance of the individual components.

Furthermore, the terms “upstream” and “downstream” refer to the relative direction with respect to fluid flow in a fluid pathway. For example, “upstream” refers to the direction from which the fluid flows, and “downstream” refers to the direction to which the fluid flows.

Additionally, the terms “low,” “high,” or their respective comparative degrees (e.g., lower, higher, where applicable) each refer to relative speeds, pressures or temperatures within an engine or thermal management system, unless otherwise specified. For example, a “low-pressure turbine” operates at a pressure generally lower than a “high-pressure turbine.” Alternatively, unless otherwise specified, the aforementioned terms may be understood in their superlative degree. For example, a “low-pressure turbine” may refer to the lowest maximum pressure turbine within a turbine section, and a “high-pressure turbine” may refer to the highest maximum pressure turbine within the turbine section.

As used herein, the terms “thermal bus” or “thermal transport bus” generally include a fluid loop or circuit formed by various fluid conduits or pipes, fluid couplings, valves, and the like. In particular embodiments, these terms may include the fluid loop or circuit, one or more pumps, one or more heat source heat exchangers, and/or one or more heat sink heat exchangers.

Precise pressure control is desired for single-phase, multiphase, or supercritical flow loops in aircraft where compressibility or thermal expansion of the thermal transport bus thermal working fluid is accommodated. A changing heat load or ambient environment may affect the average pressure of a compressible thermal working fluid in a thermal transport bus. Traditional gas-charged accumulators require an external source of gas, a pressure regulator, and a vent line, which increases the complexity of integrating the accumulator into a system. Furthermore, should a leak develop between the supply side gas and the flow loop side accumulator volume, the supply side gas may contaminate the thermal working fluid and possibly compromise the flow loop.

In general, the present subject matter is directed to a closed-loop thermal management system. The closed-loop thermal management system includes a multiphase temperature-controlled accumulator which utilizes a multiphase fluid in a multiphase fluid volume at saturated conditions whose temperature and subsequently pressure are controlled. A temperature regulator thermally coupled to the multiphase fluid volume acts to control temperature of the multiphase fluid and thus the baseline pressure of a thermal working fluid in the closed flow loop of a thermal transport bus.

Temperature control of the multiphase fluid volume may be achieved through various means such as a temperature-controlled fluid jacket or thermoelectric devices. Depending on the targeted thermal transport bus operating conditions, the multiphase fluid volume may contain a multiphase fluid which functions as a thermal working fluid flowing through the thermal transport bus. In the alternative, the multiphase fluid volume may be fluidly isolated from the thermal transport bus by a deformable membrane or piston and utilize a separate thermal working fluid for the thermal transport bus. The addition of a non-condensable gas to the multiphase fluid volume can allow for adjustment of the temperature and pressure response. In certain configurations, the closed-loop thermal management system includes additional features to ensure orientation independence (dip tubes, paired one-way valves, and gimballed mounting) and embodiments for partial heat recuperation.

This closed-loop thermal management system is applicable to closed-loop two-phase cooling systems for electronics, supercritical thermal transport busses, and power cycles. This closed-loop thermal management system eliminates the weight and volume of an external pressure source and regulator found in current thermal management systems, eliminates risk of contamination from external pressurants, and can dampen flow loop pressure transients by providing an expansion volume. The closed-loop thermal management system as disclosed may be integrated into a vehicle, such as but not limited to, an aircraft, a ground based or aircraft gas turbine engine, or any motorized vehicle or machine for cooling various accessory systems such as electronics and various lubrication systems.

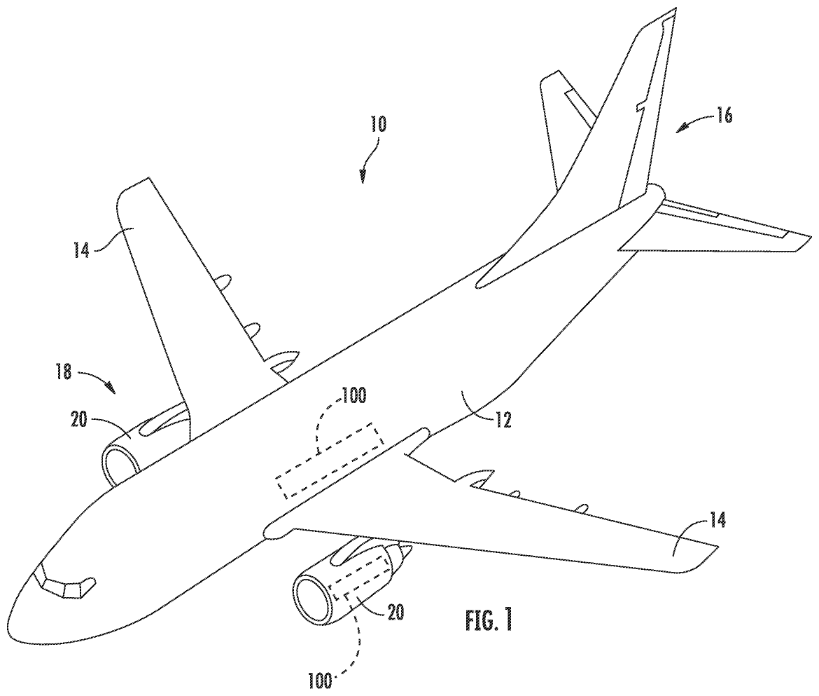

Referring now to the drawings, FIG. 1 is a perspective view of an exemplary vehicle in the form of an aircraft 10 that may incorporate at least one exemplary embodiment of the present disclosure. As shown in FIG. 1, the aircraft 10 has a fuselage 12, wings 14 attached to the fuselage 12, and an empennage 16. The aircraft 10 further includes a propulsion system 18 that produces a propulsive thrust to propel the aircraft 10 in flight, during taxiing operations, etc. Although the propulsion system 18 is shown attached to the wings 14, in other embodiments it may additionally or alternatively include one or more aspects coupled to other parts of the aircraft 10, such as, for example, the empennage 16, the fuselage 12, or both. The configuration of the aircraft 10 described above and shown in FIG. 1 is provided only to place the present subject matter in an exemplary field of use. Thus, the present subject matter may be readily adaptable to any manner of aircraft.

The propulsion system 18 includes at least one engine. In the exemplary embodiment shown, the aircraft 10 includes a pair of gas turbine engines 20. Each gas turbine engine 20 is mounted to the aircraft 10 in an under-wing configuration. Each gas turbine engine 20 is capable of selectively generating a propulsive thrust for the aircraft 10. The gas turbine engines 20 may be configured to burn various forms of fuel including, but not limited to unless otherwise provided, jet fuel/aviation turbine fuel, and hydrogen fuel.

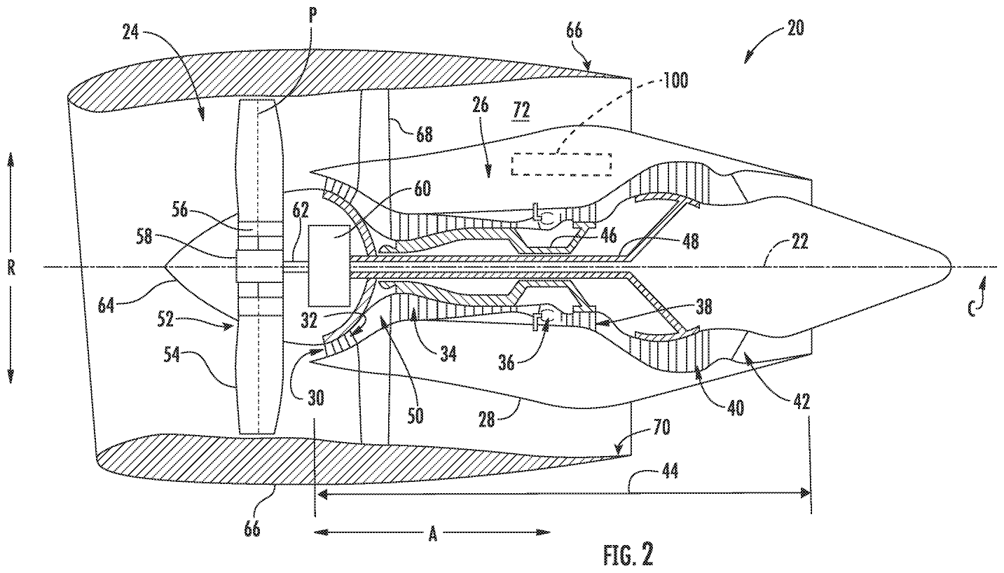

FIG. 2 is a cross-sectional side view of a gas turbine engine 20 in accordance with an exemplary embodiment of the present disclosure. More particularly, for the embodiment of FIG. 2, the gas turbine engine 20 is a multi-spool, high-bypass turbofan jet engine, sometimes also referred to as a “turbofan engine.” As shown in FIG. 2, the gas turbine engine 20 defines an axial direction “A” (extending parallel to a longitudinal centerline 22 provided for reference), a radial direction “R”, and a circumferential direction “C” extending about the longitudinal centerline 22. In general, the gas turbine engine 20 includes a fan section 24 and a turbomachine 26 disposed downstream from the fan section 24.

The turbomachine 26 depicted generally includes an engine housing, casing, or core cowl 28 that defines an annular core inlet 30. The core cowl 28 at least partially encases, in serial flow relationship, a compressor section including a booster or low-pressure compressor 32 and a high-pressure compressor 34, a combustion section 36, a turbine section including a high-pressure turbine 38 and a low-pressure turbine 40, and at least a portion of a jet exhaust nozzle 42. Together, these components or sections make up a core engine 44 of the turbomachine 26.

A high-pressure shaft 46 drivingly connects the high-pressure turbine 38 to the high-pressure compressor 34. A low-pressure shaft 48 drivingly connects the low-pressure turbine 40 to the low-pressure compressor 32. The compressor section, combustion section 36, turbine section, and jet exhaust nozzle 42 together define a working gas flow path 50 through the gas turbine engine 20.

For the embodiment depicted, the fan section 24 includes a fan 52 having a plurality of fan blades 54 coupled to a disk 56 in a spaced apart manner. As depicted, the fan blades 54 extend outwardly from disk 56 generally along the radial direction R. Each fan blade 54 is rotatable with the disk 56 about a pitch axis P by virtue of the fan blades 54 being operatively coupled to a pitch change mechanism 58 configured to collectively vary the pitch of the fan blades 54, e.g., in unison. The fan blades 54, disk 56, and pitch change mechanism 58 are together rotatable about the longitudinal centerline 22 by the low-pressure shaft 48.

In an exemplary embodiment, as shown in FIG. 2, the gas turbine engine 20 further includes a power gearbox or gearbox 60. The gearbox 60 includes a plurality of gears for adjusting a rotational speed of the fan 52 relative to a rotational speed of the low-pressure shaft 48, such that the fan 52 and the low-pressure shaft 48 may rotate at more efficient relative speeds. The gearbox 60 may be any type of gearbox suitable to facilitate coupling the low-pressure shaft 48 to the fan 52 while allowing each of the low-pressure turbine 40 and the fan 52 to operate at a desired speed. For example, in some embodiments, the gearbox 60 may be a reduction gearbox. Utilizing a reduction gearbox may enable the comparatively higher speed operation of the low-pressure turbine 40 while maintaining fan speeds sufficient to provide for increased air bypass ratios, thereby allowing for efficient operation of the gas turbine engine 20. Moreover, utilizing a reduction gearbox may allow for a reduction in turbine stages that would otherwise be present (e.g., in direct drive engine configurations), thereby providing a reduction in weight and complexity of the engine.

Referring still to the exemplary embodiment of FIG. 2, disk 56 is connected to the gearbox 60 via a fan shaft 62. The disk 56 is covered by a front hub 64 of the fan section 24 (sometimes also referred to as a “spinner”). The front hub 64 is aerodynamically contoured to promote an airflow through the plurality of fan blades 54. Additionally, the fan section 24 includes an annular fan casing or nacelle 66 that circumferentially surrounds the fan 52 and/or at least a portion of the turbomachine 26. The nacelle 66 is supported relative to the turbomachine 26 by a plurality of circumferentially spaced struts or outlet guide vanes 68 in the embodiment depicted. Moreover, a downstream section 70 of the nacelle 66 extends over an outer portion of the turbomachine 26 to define a bypass airflow passage 72 therebetween.

Furthermore, as shown in FIGS. 1 and 2, the aircraft 10 may include a closed-loop thermal management system 100 for transferring heat between fluids and/or components supporting the operation of the aircraft 10. More specifically, the aircraft 10 may include one or more accessory systems configured to support the operation of the aircraft 10. For example, in some embodiments, such accessory systems include a lubrication system that lubricates components of the gas turbine engines 20, a cooling system that provides cooling air to electronic components of the aircraft 10 and/or gas turbine engines 20, an environmental control system that provides cooled air to the cabin of the aircraft 10, and/or the like. In such embodiments, the closed-loop thermal management system 100 is configured to transfer heat from one or more fluids supporting the operation of the aircraft 10 (e.g., the oil of the lubrication system, the air of the cooling system and/or the environmental control system, and/or the like) to one or more other fluids supporting the operation of the aircraft 10 (e.g., the fuel supplied to the gas turbine engine 20). However, in alternative embodiments, the closed-loop thermal management system 100 may be configured to transfer heat between any other suitable fluids supporting the operation of the aircraft 10.

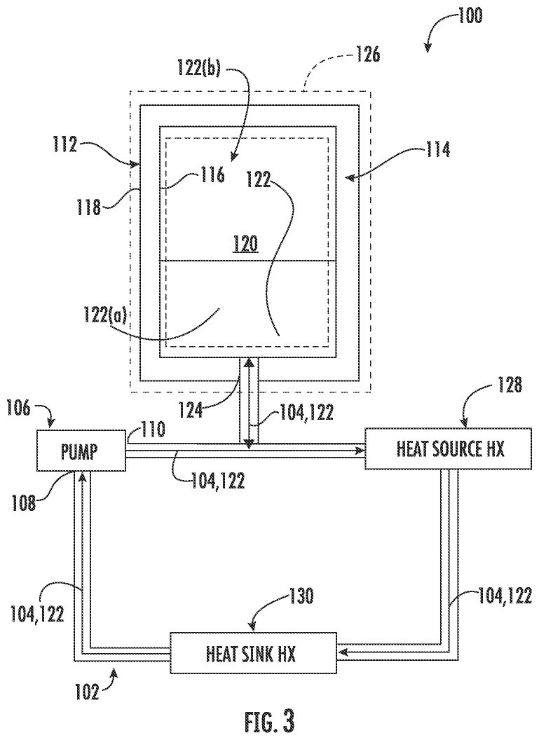

FIG. 3 is a schematic view of one embodiment of a closed-loop thermal management system 100 or “thermal management system”. In general, the closed-loop thermal management system 100 will be discussed in the context of aircraft 10 and the gas turbine engine 20 described above and shown in FIGS. 1 and 2 respectively. However, the disclosed closed-loop thermal management system 100 may be implemented within any aircraft having any other suitable configuration and/or any turbine engine having any other suitable configuration. Also, it is to be appreciated that the closed-loop thermal management system 100 described and shown herein may be integrated into other machines besides aircraft where there is high heat flux, two-phase cooling requirements, such as but not limited to electronics and computer servers, autonomous car sensors, battery recharging, etc. and is not strictly limited to use in an aircraft environment unless otherwise provided.

As shown in FIG. 3, the closed-loop thermal management system 100 includes a thermal transport bus 102. The thermal transport bus 102 is configured as one or more fluid conduits, couplings, valves, or the like, fluidly coupled together in a closed-loop, recirculating, or closed flow path configuration, through which a thermal working fluid 104 flows. For example, the thermal transport bus 102 may include a plurality of fluid conduits that are configured to circulate a working fluid therethrough. In exemplary embodiments, the closed-loop thermal management system 100 includes a pump 106 configured to provide a motive force to push or pump the thermal working fluid 104 through the thermal transport bus 102. In exemplary embodiments, the thermal transport bus 102 is fluidly connected to an inlet 108 and an outlet 110 of the pump 106 to provide a continuous flow of the heat exchange fluid through the thermal transport bus 102 in a closed-loop manner during operation.

In the exemplary embodiment shown in FIG. 3, the closed-loop thermal management system 100 further includes an accumulator 112. The accumulator 112 is at least partially formed from a pressure vessel or shell 114. The shell 114 includes an inner wall surface 116 and an outer wall surface 118. The accumulator 112 defines a multiphase fluid volume 120 within the shell 114. The multiphase fluid volume 120 is configured to hold a multiphase fluid 122 therein. The shell 114 includes an opening 124. The opening 124 is configured to provide fluid communication between the accumulator 112, more particularly the multiphase fluid volume 120, and the thermal transport bus 102.

The thermal transport bus 102, the pump 106, and the accumulator 112 are configured together as a closed-loop fluid circuit or a thermal circuit. In exemplary embodiments, as shown in FIG. 3, the multiphase fluid volume 120 is in fluid communication with the thermal transport bus 102 via opening 124 and the multiphase fluid 122 and the thermal working fluid 104 are the same fluid. In another embodiment, the multiphase fluid 122 may be fluidly isolated from the thermal working fluid 104 as will be discussed in detail below.

As shown in FIG. 3, the closed-loop thermal management system 100 further includes a device for regulating temperature or a temperature regulator 126, generally indicated by dashed lines. The temperature regulator 126 is configured to control temperature of the multiphase fluid 122 inside the multiphase fluid volume 120. In particular embodiments, the temperature of the multiphase fluid 122 may be set and regulated or maintained so that the multiphase fluid 122 includes a liquid portion 122(a).

In particular embodiments, as shown in FIG. 3, the temperature of the multiphase fluid 122 may be set and regulated or maintained so that the multiphase fluid 122 includes both a liquid portion 122(a) and a vapor or gas portion 122(b) within the multiphase fluid volume 120. The liquid portion 122(a) may be in a saturated liquid state, an unsaturated liquid state, a mixture of an undissolved gas and unsaturated liquid state, or in a subcooled liquid state (e.g. at a temperature that is less than the saturation temperature of the multiphase fluid 122). The temperature of the multiphase fluid 122 may be set and regulated or maintained by the temperature regulator 126 so that the gas portion 122(b) is in a saturated vapor state, a gas state, or a saturated vapor state with a non-condensable gas mixed with the saturated vapor within the multiphase fluid volume 120. It is to be appreciated that in other embodiments, gravity/buoyancy can be used to drive the thermal working fluid 104 around the closed flow loop, and the accumulator 112 can be used to regulate the pressure in the thermal transport bus 102.

In exemplary embodiments, the closed-loop thermal management system 100 includes one or more heat source heat exchangers 128 arranged along the thermal transport bus 102 and in thermal communication with the thermal working fluid 104. More specifically, the heat source heat exchanger 128 is fluidly coupled to the thermal transport bus 102 such that the thermal working fluid 104 flows through the heat source heat exchanger 128. In this respect, the heat source heat exchanger 128 is configured to transfer heat away heat from various accessory system of the aircraft 10 to the thermal working fluid 104. Thus, the heat source heat exchanger 128 adds heat to the thermal working fluid 104. Although FIG. 3 illustrates a single heat source heat exchanger 128, the closed-loop thermal management system 100 may include a plurality of heat source heat exchangers 128 arranged along the thermal transport bus 102.

In exemplary embodiments, the closed-loop thermal management system 100 includes a heat sink heat exchanger 130 arranged along the thermal transport bus 102 and in thermal communication with the thermal working fluid 104. More specifically, the heat sink heat exchanger 130 is fluidly coupled to the thermal transport bus 102 such that the thermal working fluid 104 flows through the heat sink heat exchanger 130. In this respect, the heat sink heat exchanger 130 is configured to transfer heat away from the thermal working fluid 104 to other fluids supporting the operation of the aircraft 10, thereby heating the other fluids supporting the operation of the aircraft 10. Although FIG. 3 illustrates a single heat sink heat exchanger 130, the closed-loop thermal management system 100 may include a plurality of heat sink heat exchangers 130 arranged along the thermal transport bus 102.

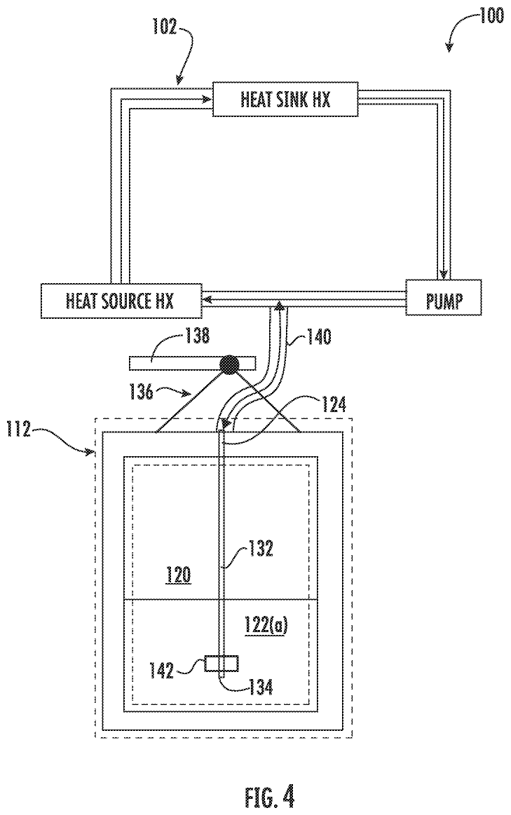

FIG. 4 is a schematic view of one embodiment of the closed-loop thermal management system 100 as shown in FIG. 3, according to an exemplary embodiment of the present disclosure. As shown in FIG. 4, accumulator 112 may include a siphon or dip tube 132. The dip tube 132 is fluidly coupled to the opening 124 and is in fluid communication with the multiphase fluid volume 120. In particular embodiments, an opening 134 of the dip tube 132 is in fluid communication with the liquid portion 122(a) of the multiphase fluid 122.

In an exemplary embodiment, the accumulator 112 is mounted to a gimbal or gimbal assembly 136. The gimbal assembly 136 may be mounted to a static structure 138 of the aircraft 10 (FIG. 1) or of the gas turbine engine 20 (FIG. 2). The gimbal assembly 136 maintains the relative orientation of the accumulator 112 to the ground or horizon so that the liquid portion 122(a) remains in fluid communication with the dip tube 132 irrespective of a relative orientation between the aircraft 10 and the ground or horizon. In an exemplary embodiment, the dip tube 132 and/or the opening 124 may be fluidly coupled to the thermal transport bus 102 via a flexible tube 140. The dip tube 132 may be rigid or in exemplary embodiments, the dip tube 132 may be flexible.

In certain configurations, particularly where the dip tube 132 is flexible, a weight 142 may be fixed or coupled to an end portion of the flexible tube 140 to keep the opening 134 of the dip tube 132 in the liquid portion 122(a) of the multiphase fluid 122. The flexible tube 140 may allow or accommodate for relative movement between the accumulator 112 and thermal transport bus 102, and the dip tube 132 may accommodate for movement of the accumulator 112 with respect to the horizon to maintain fluid contact with the liquid portion 122(a) of the multiphase fluid 122.

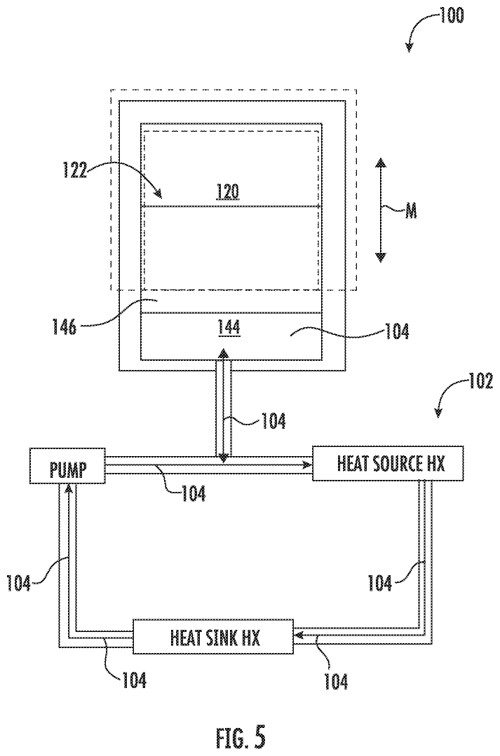

FIG. 5 is a schematic view of one embodiment of the closed-loop thermal management system 100, according to an exemplary embodiment of the present disclosure. As previously provided, in at least one embodiment, the multiphase fluid volume 120 and the multiphase fluid 122 are fluidly isolated from the thermal transport bus 102 and the thermal working fluid 104. In one embodiment, as shown in FIG. 5, the accumulator 112 includes a thermal working fluid volume 144 and a piston or movable plate 146 disposed within the accumulator 112. The movable plate 146 functions similar to a piston and fluidly isolates the multiphase fluid volume 120 and the multiphase fluid 122 from the thermal working fluid volume 144 and the thermal working fluid 104. The movable plate 146 is configured to move within the accumulator 112 in direction “M” to increase, decrease, or maintain a constant or substantially constant pressure of the thermal working fluid 104 inside the thermal transport bus 102 in response to a temperature change of the multiphase fluid 122.

FIGS. 6-10 provide schematic views of the accumulator 112 each with an exemplary temperature regulator 126 according to an embodiment of the present disclosure. Referring to FIGS. 6-10, the shell 114 of the accumulator 112 includes a wall “W” defining inner wall surface 116 and outer wall surface 118. In one embodiment, as shown in FIG. 6, the temperature regulator 126 includes at least one electric resistance heater 148. As used herein, the term “electrical resistance heater” includes resistive heating devices or processes by which an electric current passes through a conductive material (the resistor) and releases heat.

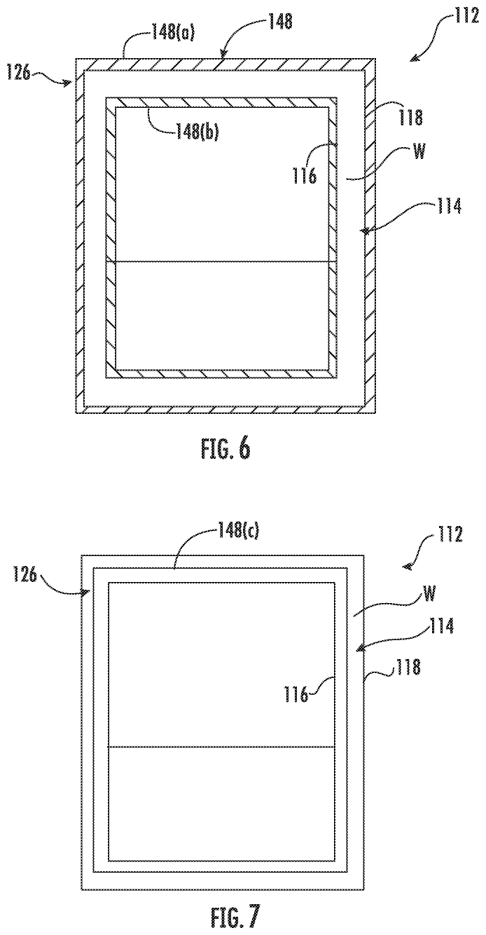

In exemplary embodiments, as shown in FIG. 6, the temperature regulator 126 may include an electric resistance heater 148(a) disposed along the outer wall surface 118. In addition, or in the alternative, the temperature regulator 126 may include an electric resistance heater 148(b) disposed along the inner wall surface 116. In another embodiment, as shown in FIG. 7, the temperature regulator 126 may include an electric resistance heater 148(c) disposed between the inner wall surface 116 and the outer wall surface 118.

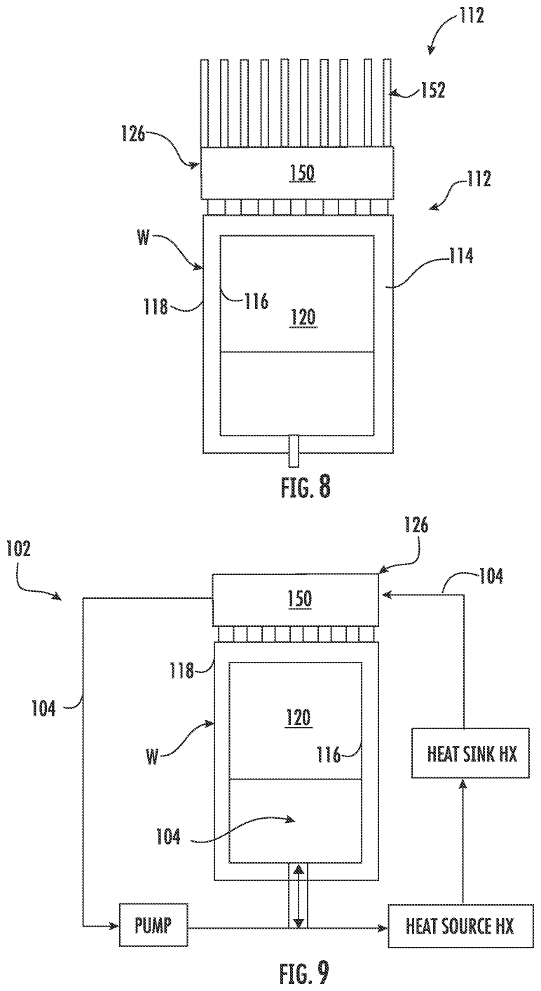

As shown in FIG. 8, the temperature regulator 126 may include a thermoelectric module 150. The thermoelectric module 150 is in thermal contact with the outer wall surface 118 of the shell 114. The thermoelectric module 150 may be configured to provide either heating or cooling to the multiphase fluid volume 120 via the wall (W) of the shell 114. In certain configurations, the thermoelectric module 150 may include various heat transfer features such but not limited to fins 152.

As shown in FIG. 9, the thermoelectric module 150 is in thermal contact with the outer wall surface 118 of shell 114. In addition, the thermoelectric module 150 is in thermal communication with the thermal working fluid 104 via the thermal transport bus 102. In this configuration, the thermoelectric module 150 may be configured to provide heating or cooling to the multiphase fluid volume 120 via the wall (W) of shell 114.

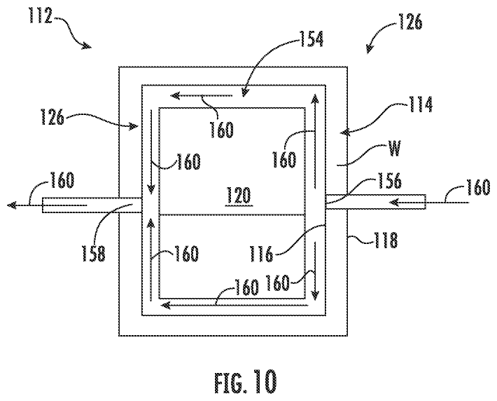

In another embodiment, as shown in FIG. 10, the temperature regulator 126 includes a thermal fluid jacket 154 at least partially disposed along the inner wall surface 116 of the wall (W). The thermal fluid jacket 154 is in fluid communication with a thermal fluid source (not shown) such as a closed loop coolant system, via an inlet 156, and an outlet 158. In operation, a thermal fluid 160 flows through the thermal fluid jacket 154 from the inlet 156, around at least a portion of the multiphase fluid volume 120, and to the outlet 158 to provide heating or cooling to the multiphase fluid 122. In the exemplary embodiment shown in FIG. 9, the thermal fluid jacket 154 is fluidly isolated from the multiphase fluid volume 120 and the multiphase fluid 122.

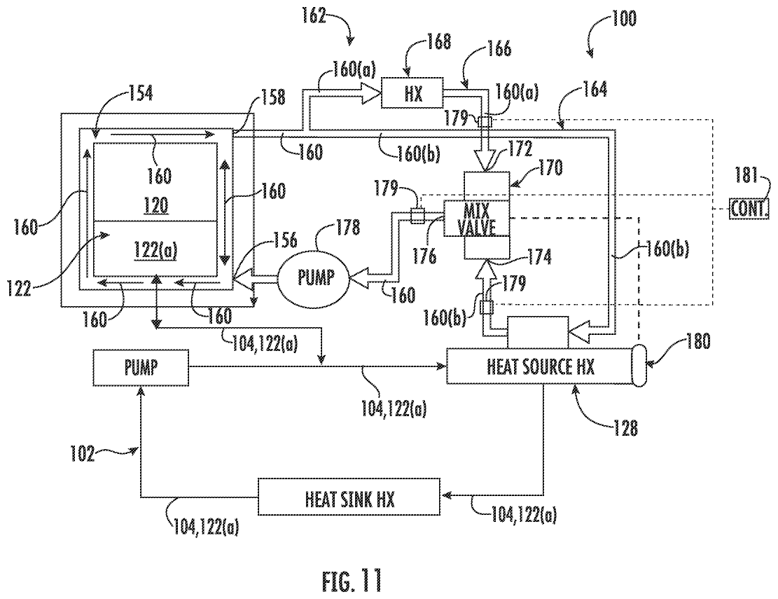

FIG. 11 is a schematic view of one embodiment of the closed-loop thermal management system 100, according to an exemplary embodiment of the present disclosure. As shown in FIG. 11, the closed-loop thermal management system 100 may include a coolant loop 162 in fluid communication with the thermal fluid jacket 154 via inlet 156 and outlet 158. The coolant loop 162 may be formed from various fluid conduits, pipes, couplers, valves, and the like which define one or more flow paths of the coolant loop 162.

In the exemplary embodiment shown in FIG. 11, the coolant loop 162 includes a primary flow circuit 164 and a bypass flow circuit 166. The bypass flow circuit 166 includes a heat sink heat exchanger 168 in thermal communication with the bypass flow circuit 166. It is to be appreciated that heat sink heat exchanger 168 may be the same as or otherwise incorporated with heat sink heat exchanger 130.

A thermal mixing valve 170 having a first inlet 172 fluidly coupled to and in fluid communication with the bypass flow circuit 166, a second inlet 174 fluidly coupled to and in fluid communication with the primary flow circuit 164, and an outlet 176 fluidly coupled to and in fluid communication with a pump 178. The pump 178 is fluidly coupled to and in fluid communication with the inlet 156 to the thermal fluid jacket 154. The pump 178 provides a motive force for moving the thermal fluid 160 through the thermal fluid jacket 154 and the coolant loop 162 in a circulating or recirculating manner. The thermal mixing valve 170 may include any valve which may be manipulated to mix the first portion 160(a) of the thermal fluid 160 with the second portion 160(b) of the thermal fluid 160 in order to heat or cool the thermal fluid 160 to a desired temperature upstream from the inlet 156 to the thermal fluid jacket 154.

One or more sensors 179 may be placed at various positions along the coolant loop 162. For example, one or more sensors 179 may be placed upstream from the thermal mixing valve 170, or downstream from the thermal mixing valve 170. The sensor(s) 179 may include, but are not limited to, temperature or pressure sensors. In operation, the sensor(s) 179 may provide a signal indicative of temperature or pressure in the coolant loop 162, to a controller 181. The controller 181 may then manipulate the thermal mixing valve 170 to mix the first portion 160(a) of the thermal fluid 160 with the second portion 160(b) of the thermal fluid 160 to adjust the temperature of the thermal fluid 160 as desired entering the thermal fluid jacket 154.

In particular embodiments, the primary flow circuit 164 is in thermal communication with the heat source heat exchanger 128 at a location that is between the bypass flow circuit 166 and the thermal mixing valve 170. In particular embodiments, a temperature probe 180 may be electrically connected to the thermal mixing valve 170.

In operation, the thermal fluid 160 flows from the outlet 158 of the thermal fluid jacket 154. A first portion 160(a) of the thermal fluid 160 may be routed through the bypass flow circuit 166 where heat is removed via the heat sink heat exchanger 168. The cooled first portion 160(a) of the thermal fluid 160 is then routed into the thermal mixing valve 170 via the first inlet 172.

A second portion 160(b) of the thermal fluid 160 flows past the bypass flow circuit 166 and is routed through or proximate to the heat source heat exchanger 128 where heat may be added to the second portion 160(b) of the thermal fluid 160. The heated second portion 160(b) is then routed to the thermal mixing valve 170 via the second inlet 174. The thermal mixing valve 170 mixes the first portion 160(a) and the second portion 160(b) of the thermal fluid 160 to achieve a desired temperature of the thermal fluid 160 before it is routed back into the inlet 156 of the thermal fluid jacket 154 via the pump 178. A desired amount of mixing may be at least partially determined by a temperature reading of the second portion 160(b) of the thermal fluid 160 or the thermal working fluid 104, or multiphase fluid 122 as measured at the heat source heat exchanger 128.

An increase in the temperature of the thermal fluid 160 flowing through the thermal fluid jacket 154 results in an increase in the pressure in the multiphase fluid volume 120 causing the liquid portion 122(a) of the multiphase fluid 122 to flow into the thermal transport bus 102, thereby regulating the pressure in the thermal transport bus 102. Likewise, a decrease in the temperature of the thermal fluid 160 flowing through the thermal fluid jacket 154 results in a decrease in the pressure in multiphase fluid volume 120 resulting in a backflow of the liquid portion 122(a) of the multiphase fluid 122 from the thermal transport bus 102 into the multiphase fluid volume 120, thereby regulating the pressure within the thermal transport bus 102.

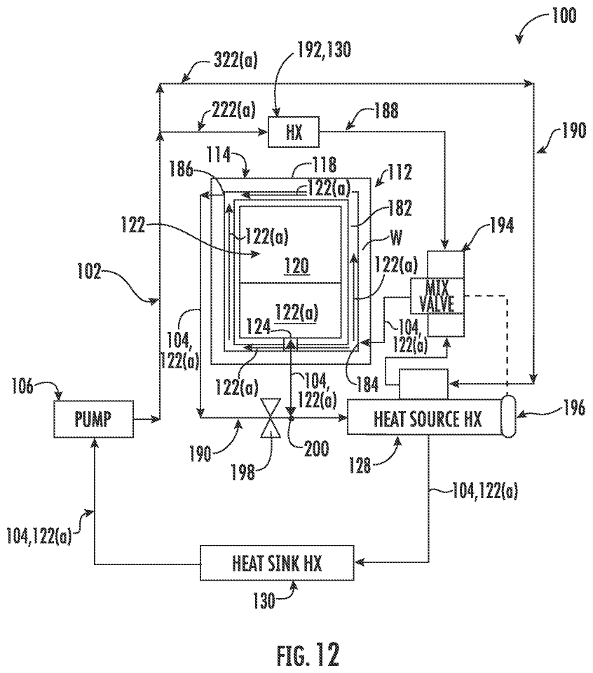

FIG. 12 is a schematic view of one embodiment of the closed-loop thermal management system 100, according to an exemplary embodiment of the present disclosure. As shown in FIG. 12, the thermal transport bus 102, more specifically the accumulator 112, includes a multiphase fluid channel 182 defined within the wall (W) between the inner wall surface 116 and the outer wall surface 118. The multiphase fluid channel 182 extends at least partially around the multiphase fluid volume 120 and defines a flow path for routing the multiphase fluid 122 through the shell 114. The multiphase fluid channel 182 includes an inlet 184 and an outlet 186 which are fluidly connected to and provide for fluid communication between the multiphase fluid channel 182 and the thermal transport bus 102. In this configuration, the thermal working fluid 104 and/or the multiphase fluid 122 are one and the same.

The thermal transport bus 102 includes a bypass flow circuit 188 and a primary flow circuit 190 fluidly coupled to and in fluid communication with outlet 186. A secondary heat sink heat exchanger 192 is in thermal communication with the bypass flow circuit 188. A thermal mixing valve 194 is disposed downstream from the bypass flow circuit 188 and upstream from the inlet 184. The pump 106 provides a motive force for moving the multiphase fluid 122 through the primary flow circuit 190, the bypass flow circuit 188, the thermal mixing valve 194 and back into the multiphase fluid channel 182. In particular embodiments, a temperature probe 196 may be electrically connected to the thermal mixing valve 194.

In exemplary embodiments, the thermal transport bus 102 includes a backpressure valve 198. The backpressure valve 198 is fluidly coupled to the thermal transport bus 102 downstream from the outlet 186 of the multiphase fluid channel 182 and upstream from a fluid connection point 200 wherein the accumulator 112 connects to the thermal transport bus 102 via opening 124. In operation, the backpressure valve 198 ensures that the flow of the thermal working fluid 104 flowing from the outlet 186 of the multiphase fluid channel 182 and to fluid connection point 200 is at a higher pressure than the portion of the thermal working fluid 104 flowing from the opening 124 of the accumulator 112 and to the fluid connection point 200. This further ensures that the portion of the thermal working fluid 104 flowing through/from the multiphase fluid channel 182 is warmer than the portion of the thermal working fluid 104 flowing from the accumulator 112 without boiling.

In operation the multiphase fluid 122, particularly the liquid portion 122(a) flows out of the multiphase fluid channel 182 via outlet 186, through the heat source heat exchanger 128 where heat is added thereto. The liquid portion 122(a) of the multiphase fluid 122 then passes through the heat sink heat exchanger 130 where heat is removed from the liquid portion 122(a) of the multiphase fluid 122. Liquid portion 122(a) of the multiphase fluid 122 then passes through the pump 106. A first portion 222(a) of the liquid portion 122(a) of the multiphase fluid 122 is directed through the bypass flow circuit 188 wherein it passes through the secondary heat sink heat exchanger 192, thereby further cooling the first portion 222(a) of the liquid portion 122(a) of the multiphase fluid 122. The first portion 222(a) of the multiphase fluid 122 is then routed to thermal mixing valve 194. It is to be appreciated that secondary heat sink heat exchanger 192 may be the same heat sink heat exchanger as heat sink heat exchanger 130 or may be a separate heat sink heat exchanger.

A second portion 322(a) of the liquid portion 122(a) of the multiphase fluid 122 is routed past the bypass flow circuit 188 and back through the heat source heat exchanger 128 which adds heat the second portion 322(a). The second portion 322(a) of the liquid portion 122(a) of the multiphase fluid 122 is then routed to the thermal mixing valve 194.

The thermal mixing valve 194 mixes the first portion 222(a) and the second portion 322(a) of the liquid portion 122(a) of the multiphase fluid 122 to achieve a desired temperature of the liquid portion 122(a) of the multiphase fluid 122 before it is routed back into the inlet 184 of the multiphase fluid channel 182, thereby adjusting or maintaining the temperature of a portion of the multiphase fluid 122 disposed within the multiphase fluid volume 120. A desired amount of mixing may be at least partially determined by a pre-determined or desired temperature of a heat load. For example, if the closed-loop thermal management system 100 is being utilized to cool a CPU, the CPU may need to operate at a certain temperature or within a certain temperature range. As such, the temperature probe 196 measures the temperature of the CPU and a controller controls the thermal mixing valve 194 until the desired CPU temperature is achieved.

An increase in the temperature of the liquid portion 122(a) of the multiphase fluid 122 flowing through the multiphase fluid channel 182 results in an increase in the pressure in the multiphase fluid volume 120 causing the liquid portion 122(a) of the multiphase fluid 122 to flow into the thermal transport bus 102, thereby regulating the pressure in the thermal transport bus 102. Likewise, a decrease in the temperature of the gas portion 122(b) of the multiphase fluid 122 results in a decrease in the pressure in the multiphase fluid volume 120 resulting in a backflow of the liquid portion 122(a) of the multiphase fluid 122 from the thermal transport bus 102 into the multiphase fluid volume 120, thereby regulating the pressure within the thermal transport bus 102.

The closed-loop thermal management system disclosed herein enables precise control of pressure within a thermal transport bus loop irrespective of environmental conditions and does so with increased simplicity and ease of integration. For example, the pressure response of the accumulator is proportional to the pressure-temperature behavior of the thermal working fluid flowing through the thermal transport bus. For example, pressure response is about 22 psi/° C. for CO2 or 3 psi/° C. for R134a.

This closed-loop thermal management system can control pressure for both non-compressible and compressible flow loop working fluids. By controlling the temperature of the multiphase fluid in the multiphase fluid volume, the pressure in the thermal transport bus can be controlled as needed. Temperature control of the multiphase fluid volume also minimizes the impact of environmental heat leak, as the temperature of the fluid can be controlled externally via a feedback controller and actuated by electric heaters, thermo-electrics, or other means instead of being dependent on ambient conditions. Using temperature to control pressure in the closed-loop thermal management system, particularly the thermal transport bus, eliminates the need for external high-pressure gas/vent lines, and additional components such as valves, used in gas-charged accumulators.

This written description uses examples to disclose the present disclosure, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A closed-loop thermal management system, comprising: a thermal transport bus configured to circulate a thermal working fluid therethrough; an accumulator including a shell defining a multiphase fluid volume therein, a multiphase fluid at least partially disposed within the multiphase fluid volume, and an opening configured to provide for fluid communication between the accumulator and the thermal transport bus, wherein the thermal transport bus, and the accumulator are configured as a closed-loop fluid circuit; and a temperature regulator configured to control a temperature of the multiphase fluid inside the multiphase fluid volume, wherein the multiphase fluid regulates a pressure of the thermal working fluid flowing through the thermal transport bus based on the temperature of the multiphase fluid.

A closed-loop thermal management system including a thermal transport bus including a plurality of fluid conduits configured to circulate a thermal working fluid therethrough, an accumulator including a shell defining a multiphase fluid volume therein configured to contain a multiphase fluid, the shell defining an opening, wherein the accumulator is fluidly coupled to the thermal transport bus in a closed-loop fluid circuit, and a temperature regulator configured to control a temperature of the multiphase fluid inside the multiphase fluid volume.

The closed-loop thermal management system of any previous or any following clause, wherein the thermal working fluid comprises the multiphase fluid.

The closed-loop thermal management system of any previous or following clause, further comprising a heat source heat exchanger in thermal communication with the thermal working fluid.

The closed-loop thermal management system of any previous or following clause, further comprising a heat sink heat exchanger in thermal communication with the thermal working fluid.

The closed-loop thermal management system of any previous or following clause, wherein the multiphase fluid includes a liquid portion in a saturated liquid state and a gas portion in a saturated vapor state within the multiphase fluid volume.

The closed-loop thermal management system of any previous or following clause, further comprising a pump having an inlet and an outlet fluidly coupled to the thermal transport bus, wherein the thermal transport bus, the pump, and the accumulator are configured as a closed-loop fluid circuit.

The closed-loop thermal management system of any previous or following clause, wherein the multiphase fluid includes a liquid portion, a gas portion, and a dissolved gas mixed with the liquid portion within the multiphase fluid volume.

The closed-loop thermal management system of any previous or following clause, wherein the multiphase fluid includes a gas portion, a non-condensable gas, and a liquid portion within the multiphase fluid volume.

The closed-loop thermal management system of any previous or following clause, wherein the multiphase fluid includes a gas portion in a saturated vapor state, a non-condensable gas mixed with the saturated vapor, and a liquid portion in a saturated liquid state within the multiphase fluid volume.

The closed-loop thermal management system of any previous or following clause, wherein the multiphase fluid is a subcooled liquid within the multiphase fluid volume.

The closed-loop thermal management system of any previous or following clause, wherein the accumulator further comprises a dip tube fluidly coupled to the opening.

The closed-loop thermal management system of any previous or following clause, wherein the multiphase fluid includes a liquid portion in a saturated liquid state and a gas portion in a saturated vapor state, wherein the dip tube is in fluid communication with the liquid portion.

The closed-loop thermal management system of any previous or following clause, further comprising a weight coupled to the dip tube.

The closed-loop thermal management system of any previous or following clause, wherein the accumulator is mounted to a gimbal support.

The closed-loop thermal management system of any previous or following clause, wherein the shell of the accumulator comprises a wall defining an inner wall surface and an outer wall surface, wherein the temperature regulator comprises at least one electric resistance heater disposed along at least one of the outer wall surface and the inner wall surface.

The closed-loop thermal management system of any previous or following clause, wherein the shell of the accumulator comprises a wall defining an outer wall surface, wherein the temperature regulator comprises a thermoelectric module in thermal contact with the outer wall surface.

The closed-loop thermal management system of any previous or following clause, wherein the thermoelectric module is in thermal contact with the thermal transport bus.

The closed-loop thermal management system of any previous or following clause, wherein the shell of the accumulator comprises a wall defining an inner wall surface and an outer wall surface, wherein the temperature regulator comprises a thermal fluid jacket at least partially disposed along the inner wall surface.

The closed-loop thermal management system of any previous or following clause, further comprising a coolant loop in fluid communication with the thermal fluid jacket.

The closed-loop thermal management system of any previous or following clause, wherein the shell defines a fluid channel between the inner wall surface and the outer wall surface, the fluid channel including an inlet and an outlet, wherein the fluid channel is fluidly coupled to the thermal transport bus via the inlet, the outlet, and the opening of the accumulator.

The closed-loop thermal management system of any previous or following clause, wherein the accumulator further comprises a thermal working fluid volume and a movable plate, wherein the movable plate fluidly isolates the multiphase fluid volume from the thermal working fluid volume.

The closed-loop thermal management system of any previous clause, wherein the movable plate is configured to move to increase pressure or decrease pressure inside the thermal transport bus in response to a temperature change of the multiphase fluid.

The closed-loop thermal management system of any previous or following clause, further comprising at least one sensor and a controller, further comprising at least one sensor and a controller, wherein the at least one sensor is configured to send a signal indicative of a temperature or a pressure of the thermal working fluid to the controller, wherein the controller is configured to manipulate a thermal mixing valve in response to the signal.

A vehicle comprising a thermal transport bus configured to circulate a thermal working fluid therethrough, an accumulator including a shell defining a multiphase fluid volume therein, a multiphase fluid at least partially disposed within the multiphase fluid volume, and an opening configured to provide for fluid communication between the accumulator and the thermal transport bus, wherein the thermal transport bus, and the accumulator are configured as a closed-loop fluid circuit; and a temperature regulator configured to control a temperature of the multiphase fluid inside the multiphase fluid volume, wherein the multiphase fluid regulates a pressure of the thermal working fluid flowing through the thermal transport bus based on the temperature of the multiphase fluid.

A vehicle, comprising a thermal transport bus including a plurality of fluid conduits configured to circulate a thermal working fluid therethrough, an accumulator including a shell defining a multiphase fluid volume therein configured to contain a multiphase fluid, the shell defining an opening, wherein the accumulator is fluidly coupled to the thermal transport bus in a closed-loop fluid circuit, and a temperature regulator configured to control a temperature of the multiphase fluid inside the multiphase fluid volume.

The vehicle of the preceding clause, further comprising at least one of a heat source heat exchanger and a heat sink heat exchanger in thermal communication with the thermal working fluid.

The vehicle of any previous or any following clause, wherein the thermal working fluid comprises the multiphase fluid.

The vehicle of any previous or following clause, wherein the multiphase fluid includes a liquid portion in a saturated liquid state and a gas portion in a saturated vapor state within the multiphase fluid volume.

The vehicle of any previous or following clause, further comprising a pump having an inlet and an outlet fluidly coupled to the thermal transport bus, wherein the thermal transport bus, the pump, and the accumulator are configured as a closed-loop fluid circuit.

The vehicle of any previous or following clause, wherein the multiphase fluid includes a liquid portion, a gas portion, and a dissolved gas mixed with the liquid portion within the multiphase fluid volume.

The vehicle of any previous or following clause, wherein the multiphase fluid includes a gas portion, a non-condensable gas, and a liquid portion within the multiphase fluid volume.

The vehicle of any previous or following clause, wherein the multiphase fluid includes a gas portion in a saturated vapor state, a non-condensable gas mixed with the saturated vapor, and a liquid portion in a saturated liquid state within the multiphase fluid volume.

The vehicle of any previous or following clause, wherein the multiphase fluid is a subcooled liquid within the multiphase fluid volume.

The vehicle of any previous or following clause, wherein the accumulator further comprises a dip tube fluidly coupled to the opening.

The vehicle of any previous or following clause, wherein the multiphase fluid includes a liquid portion in a saturated liquid state and a gas portion in a saturated vapor state, wherein the dip tube is in fluid communication with the liquid portion.

The vehicle of any previous or following clause, further comprising a weight coupled to the dip tube.

The vehicle of any previous or following clause, wherein the accumulator is mounted to a gimbal support.

The vehicle of any previous or following clause, wherein the shell of the accumulator comprises a wall defining an inner wall surface and an outer wall surface, wherein the temperature regulator comprises at least one electric resistance heater disposed along at least one of the outer wall surface and the inner wall surface.

The vehicle of any previous or following clause, wherein the shell of the accumulator comprises a wall defining an outer wall surface, wherein the temperature regulator comprises a thermoelectric module in thermal contact with the outer wall surface.

The vehicle of any previous or following clause, wherein the thermoelectric module is in thermal contact with the thermal transport bus.

The vehicle of any previous or following clause, wherein the shell of the accumulator comprises a wall defining an inner wall surface and an outer wall surface, wherein the temperature regulator comprises a thermal fluid jacket at least partially disposed along the inner wall surface.

The vehicle of any previous or following clause, further comprising a coolant loop in fluid communication with the thermal fluid jacket.

The vehicle of any previous or following clause, wherein the shell defines a fluid channel between the inner wall surface and the outer wall surface, the fluid channel including an inlet and an outlet, wherein the fluid channel is fluidly coupled to the thermal transport bus via the inlet, the outlet, and the opening of the accumulator.

The vehicle of any previous or following clause, wherein the accumulator further comprises a thermal working fluid volume and a movable plate, wherein the movable plate fluidly isolates the multiphase fluid volume from the thermal working fluid volume.

The vehicle of any previous clause, wherein the movable plate is configured to move to increase pressure or decrease pressure inside the thermal transport bus in response to a temperature change of the multiphase fluid.

The vehicle of any previous or proceeding clause, wherein the vehicle comprises a gas turbine engine, wherein the closed-loop thermal management system is thermally coupled to the gas turbine engine.

The vehicle of any previous or following clause, further comprising at least one sensor and a controller, wherein the at least one sensor is configured to send a signal indicative of a temperature or a pressure of the thermal working fluid to the controller, wherein the controller is configured to manipulate a thermal mixing valve in response to the signal.

We claim:

1. A closed-loop thermal management system, comprising:
a thermal transport bus including a plurality of fluid conduits configured to circulate a thermal working fluid therethrough;
an accumulator including a shell defining a multiphase fluid volume therein configured to contain a multiphase fluid, the shell defining an opening, wherein the accumulator is fluidly coupled to the thermal transport bus in a closed-loop fluid circuit; and
a temperature regulator configured to control a temperature of the multiphase fluid inside the multiphase fluid volume.

2. The closed-loop thermal management system of claim 1, wherein the thermal working fluid comprises the multiphase fluid.

3. The closed-loop thermal management system of claim 1, further comprising a heat source heat exchanger in thermal communication with the thermal working fluid.

4. The closed-loop thermal management system of claim 1, further comprising a heat sink heat exchanger in thermal communication with the thermal working fluid.

5. The closed-loop thermal management system of claim 1, wherein the multiphase fluid includes a liquid portion in a saturated liquid state and a gas portion in a saturated vapor state within the multiphase fluid volume.

6. The closed-loop thermal management system of claim 1, further comprising a pump having an inlet and an outlet fluidly coupled to the thermal transport bus, wherein the closed-loop fluid circuit includes the thermal transport bus, the pump, and the accumulator.

7. The closed-loop thermal management system of claim 1, wherein the accumulator further comprises a dip tube fluidly coupled to the opening.

8. The closed-loop thermal management system of claim 7, wherein the multiphase fluid includes a liquid portion in a saturated liquid state and a gas portion in a saturated vapor state, wherein the dip tube is in fluid communication with the liquid portion.

9. The closed-loop thermal management system of claim 7, further comprising a weight coupled to the dip tube.

10. The closed-loop thermal management system of claim 7, further comprising a gimbal support, wherein the accumulator is mounted to the gimbal support.

11. The closed-loop thermal management system of claim 1, wherein the shell of the accumulator comprises a wall defining an inner wall surface and an outer wall surface, wherein the temperature regulator comprises at least one electric resistance heater disposed along at least one of the outer wall surface and the inner wall surface.

12. The closed-loop thermal management system of claim 1, wherein the shell of the accumulator comprises a wall defining an outer wall surface, wherein the temperature regulator comprises a thermoelectric module in thermal contact with the outer wall surface.

13. The closed-loop thermal management system of claim 12, wherein the thermoelectric module is in thermal contact with the thermal transport bus.

14. The closed-loop thermal management system of claim 1, wherein the shell of the accumulator comprises a wall defining an inner wall surface and an outer wall surface, wherein the temperature regulator comprises a thermal fluid jacket at least partially disposed along the inner wall surface.

15. The closed-loop thermal management system of claim 14, further comprising a coolant loop in fluid communication with the thermal fluid jacket.

16. The closed-loop thermal management system of claim 14, wherein the shell defines a fluid channel between the inner wall surface and the outer wall surface, the fluid channel including an inlet and an outlet, wherein the fluid channel is fluidly coupled to the thermal transport bus via the inlet, the outlet, and the opening of the accumulator.

17. The closed-loop thermal management system of claim 1, wherein the accumulator further comprises a thermal working fluid volume and a movable plate, wherein the movable plate fluidly isolates the multiphase fluid volume from the thermal working fluid volume.

18. The closed-loop thermal management system of claim 17, wherein the movable plate is configured to move to increase pressure or decrease pressure of the thermal working fluid inside the thermal transport bus in response to a temperature change of the multiphase fluid.

19. A vehicle, comprising:
a thermal transport bus including a plurality of fluid conduits configured to circulate a thermal working fluid therethrough;
an accumulator including a shell defining a multiphase fluid volume therein configured to contain a multiphase fluid, the shell defining an opening, wherein the accumulator is fluidly coupled to the thermal transport bus in a closed-loop fluid circuit; and
a temperature regulator configured to control a temperature of the multiphase fluid inside the multiphase fluid volume.

20. The vehicle of claim 19, further comprising at least one of a heat source heat exchanger and a heat sink heat exchanger in thermal communication with the thermal working fluid.
